(19) United States
(12) Patent Application Publication
(10) Pub. No.: US 2024/0192333 A1
(43) Pub. Date: Jun. 13, 2024

(54) RANGING APPARATUS, OPTICAL INTEGRATED CIRCUIT, AND RANGING SYSTEM

(71) Applicant: Sony Semiconductor Solutions Corporation, Kanagawa (JP)

(72) Inventor: Haruhiko Terada, Kanagawa (JP)

(21) Appl. No.: 18/554,352

(22) PCT Filed: Feb. 8, 2022
(86) PCT No.: PCT/JP2022/004808

§ 371 Date: Oct. 6, 2023

(30) Foreign Application Priority Data
May 27, 2021 (JP) 2021-088883

(51) Int. Cl. G01S 7/481; G01S 7/4911; G01S 7/4914

(52) U.S. Cl. CPC G01S 7/4817; G01S 7/4911; G01S 7/4914

(57) ABSTRACT

The present disclosure relates to a ranging apparatus, an optical integrated circuit, and a ranging system that allow ranging with higher angular resolutions to be carried out.

Provided is a ranging apparatus including a scanner unit having pixel arrays each including a plurality of pixels connected by one waveguide, the pixels are arranged at a prescribed pitch in a first direction in the same direction as that of the waveguide, the pixel array serves as one channel, the scanner unit includes a plurality of channels, and the plurality of channels are arranged in a second direction crossing the first direction, shifted between channels by a prescribed width smaller than the prescribed pitch. The present disclosure can be applied to a ranging apparatus that performs ranging for example by FMCW LiDAR.

### TECHNICAL FIELD

The present disclosure relates to a ranging apparatus, an optical integrated circuit, and a ranging system, and more particularly to a ranging apparatus, an optical integrated circuit, and a ranging system that allow ranging to be carried out with higher angular resolutions.

### BACKGROUND ART

LiDAR (Light Detection and Ranging) is a distance measurement technique based on the measurement of scattered light in response to laser irradiation and is applied to various applications including automated driving. There has been a demand for a LiDAR technique that enables measurement with higher angular resolutions for detecting small obstacles in the distance, especially when automated driving on highways is envisioned.

One of the key elements of LiDAR is a device called a scanner (deflector) that carries out scanning in the direction of laser irradiation. One scanner of this type is a 2D scanner using MEMS (Micro Electro Mechanical Systems) grating switches.

PTL 1 discloses an optical switch provided at an upper part of an optical waveguide made by silicon photonics and having a grating structure that can be moved by electrostatic MEMS. PTL 1 also indicates that the optical switch is operated as a switch capable of controlling a function thereof as a light emitter or a light receiver between valid (on) and invalid (off) states, and that pixels are connected by an optical waveguide in a 2D arrangement, with such a switch serving as one pixel and being used as a 2D scanner.

### CITATION LIST

### Patent Literature

[PTL 1]
Japanese Translation of PCT Application No. 2020-523630

### SUMMARY

### Technical Problem

In order to achieve high angular resolutions using the 2D scanner, the MEMS grating switches need to be miniaturized, which may make manufacturing more difficult and cause lower yields and reliability.

With the foregoing in view, the present disclosure is directed to allowing ranging to be carried out with higher angular resolutions.

### Solution to Problem

A ranging apparatus according to one aspect of the disclosure includes a scanner unit that has pixel arrays each including a plurality of pixels connected by one waveguide, wherein the pixels are arranged at a prescribed pitch in a first direction in the same direction as that of the waveguide, the pixel array serves as one channel, the scanner unit includes a plurality of channels, and the plurality of channels are arranged in a second direction crossing the first direction, and shifted between channels by a prescribed width smaller than the prescribed pitch.

The ranging apparatus according to the aspect of the disclosure includes a scanner unit that has pixel arrays each including a plurality of pixels connected by one waveguide, wherein the pixels are arranged at a prescribed pitch in a first direction in the same direction as that of the waveguide. The scanner unit includes a plurality of channels with the pixel array serving as one channel, and the plurality of channels are arranged in a second direction crossing the first direction, and shifted between channels by a prescribed width smaller than the prescribed pitch.

An optical integrated circuit according to another aspect of the present disclosure includes a light source unit configured to generate chirped light, a scanner unit that has pixel arrays each including a plurality of pixels connected by one waveguide, the pixels being arranged at a prescribed pitch in a first direction in the same direction as that of the waveguide, and a splitting detection unit configured to supply transmission light obtained by splitting the chirped light to the scanner unit and detect received light from the scanner unit, the scanner unit includes a plurality of channels with the pixel array serving as one channel, and the plurality of channels are arranged in a second direction crossing the first direction, and shifted between channels by a prescribed width smaller than the prescribed pitch.

The optical integrated circuit according to the aspect of the present disclosure includes a light source unit configured to generate chirped light, a scanner unit that has pixel arrays each including a plurality of pixels connected by one waveguide, the pixels being arranged at a prescribed pitch in a first direction in the same direction as that of the waveguide, and a splitting detection unit configured to supply transmission light obtained by splitting the chirped light to the scanner unit and detect received light from the scanner unit. The scanner unit includes a plurality of channels with the pixel array serving as one channel, and the plurality of channels are arranged in a second direction crossing the first direction, and shifted between channels by a prescribed width smaller than the prescribed pitch.

A ranging system according to another aspect of the present disclosure includes: an optical integrated circuit that includes a light source unit configured to generate chirped light, a scanner unit that has pixel arrays each including a plurality of pixels connected by one waveguide, the pixels being arranged at a prescribed pitch in a first direction in the same direction as that of the waveguide, and a splitting detection unit configured to supply transmission light obtained by splitting the chirped light to the scanner unit and detect received light from the scanner unit; and an external scanner configured to at least carry out scanning in a second direction crossing the first direction, the scanner unit includes a plurality of channels, with the pixel array serving as one channel, and the plurality of channels are arranged in the second direction, and shifted between channels by a prescribed width smaller than the prescribed pitch.

The ranging system according to the aspect of the present disclosure includes: an optical integrated circuit that includes a light source unit configured to generate chirped light, a scanner unit that has pixel arrays each including a plurality of pixels connected by one waveguide, the pixels being arranged at a prescribed pitch in a first direction in the same direction as that of the waveguide, and a splitting detection unit configured to supply transmission light obtained by splitting the chirped light to the scanner unit and detect received light from the scanner unit; and an external scanner configured to at least carry out scanning in a second direction crossing the first direction. The scanner unit includes a plurality of channels, with the pixel array serving as one channel, and the plurality of channels are arranged in the second direction, and shifted between channels by a prescribed width smaller than the prescribed pitch.

The ranging apparatus and the optical integrated circuit according to the aspects of the present disclosure may be an independent apparatus or may be an internal block of one apparatus.

### BRIEF DESCRIPTION OF DRAWING

FIG. 1 is a view of an exemplary structure of a ranging system to which the present disclosure is applied.

FIG. 2 is a diagram of a detailed exemplary configuration of the SiP in FIG. 1.

FIG. 3 illustrates an exemplary structure of an optical integrated circuit to which the present disclosure is applied.

FIG. 4 illustrates the principles of how measurement works by a ranging system to which the present disclosure is applied.

FIG. 5 illustrates the principles of how measurement works by the ranging system to which the present disclosure is applied.

FIG. 6 illustrates a detailed exemplary structure of the scanner unit in FIG. 3.

FIG. 7 illustrates a scanning method by the ranging system to which the present disclosure is applied.

FIG. 8 illustrates a scanning method by the ranging system to which the present disclosure is applied.

FIG. 9 illustrates another exemplary structure of an optical integrated circuit to which the present disclosure is applied.

### DESCRIPTION OF EMBODIMENTS

### 1. Embodiments of Present Disclosure

### (Overview of System)

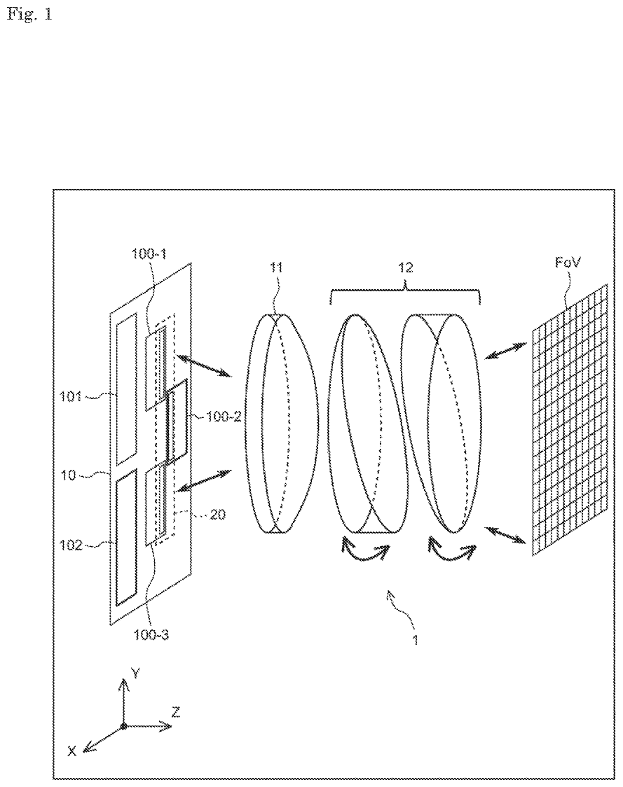

FIG. 1 is a view of an exemplary structure of a ranging system to which the present disclosure is applied.

The ranging system 1 carries out ranging according to FMCW LiDAR (Frequency Modulated Continuous Wave Light Detection and Ranging). According to FMCW LiDAR, ranging is carried out by performing frequency modulation to a light source and reading changes in frequency between the light transmitted with the modulation and reflected light thereof.

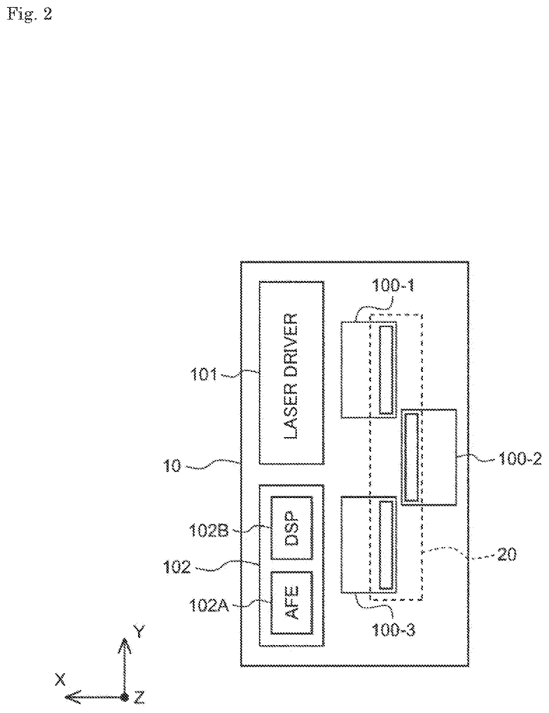

In FIG. 1, the ranging system 1 includes an SiP 10, a collimator 11, and an external scanner 12. FIG. 2 illustrates a detailed exemplary configuration of the SiP 10.

In FIG. 2, the SiP 10 includes three chips, optical integrated circuits 100-1 to 100-3, the IC of a laser driver 101, and the IC of a signal processing circuit 102 on one package substrate in an integrated manner as a SiP (System in Package).

The signal processing circuit 102 includes an AFE 102A and a DSP 102B. The AFE 102A is an AFE (Analog Front End) that converts an analog output from a detector into a digital signal sequence. The DSP 102B is a DSP (Digital Signal Processor) that performs spectrum analysis and peak detection.

In the SiP 10, each of the optical integrated circuits 100-1 to 100-3 can be configured with four channels, each of which serves as one pixel array, so that using a single circuit, four beams can be emitted and received simultaneously and four-point ranging and velocity measurement can be performed simultaneously.

In the SiP 10, the optical integrated circuits 100-1 to 100-3 are operated simultaneously to allow ranging to be carried out at 12 points simultaneously in other words, the SiP operates as a ranging apparatus compatible with a 12-channel LiDAR system.

As shown in FIG. 2, the optical integrated circuit 100-2 located in the center among the optical integrated circuits 100-1 to 100-3 is turned 180° to allow the pixel array to be mounted on the package nearly along a straight line to provide a 1D scanner array 20. In this way the optical integrated circuits 100-1 to 100-3 can serve like a line sensor having a length three times the size of the long side of each of the optical integrated circuits.

Such packaging can provide an effective light-receiving area equivalent to that achieved by a single large-area optical integrated circuit in a smaller area with multiple optical integrated circuits arranged side by side, so the overall manufacturing cost can be lowered. In the following description, the optical integrated circuits 100-1 to 100-3 will be each referred to as the “optical integrated circuit 100” unless it is necessary to distinguish among them.

The ranging system 1 includes, in combination with the SiP 10, the collimator 11 as an optical system that converts outgoing and incoming light from/to the pixel arrays into collimated light, and the external scanner 12, so that the field of view FoV of a target for ranging is irradiated with light transmitted from the optical integrated circuits 100, and distance information can be obtained from reflected light therefrom. In FIG. 1, the field of view (FoV) of the target for ranging by the ranging system 1 is represented by a 2D grid region.

For example, a Risley prism can be used as the external scanner 12. The Risley prism is a light deflector that includes a combination of two circular prisms (wedge prisms) having a prescribed declination angle, each of which can be rotated by a motor. By rotating the two prisms reversely with respect to each other at the same number of revolutions, scanning in a reciprocating scanning pattern in a single direction (1D scanning) is allowed.

The 1D scanning direction can be adjusted among the horizontal and vertical directions or diagonal directions by changing the rotation starting position of each of the prisms. As shown in FIG. 1, in the ranging system 1, the SiP 10 has a 1D pixel array in the vertical direction (the Y direction in the figure), and therefore, as the external scanner 12 such as the Risley prism is operated for 1D scanning in the horizontal direction (in the X direction in the figure), the 2D field of view FoV can be subjected to ranging.

### (Configuration of Optical Integrated Circuit)

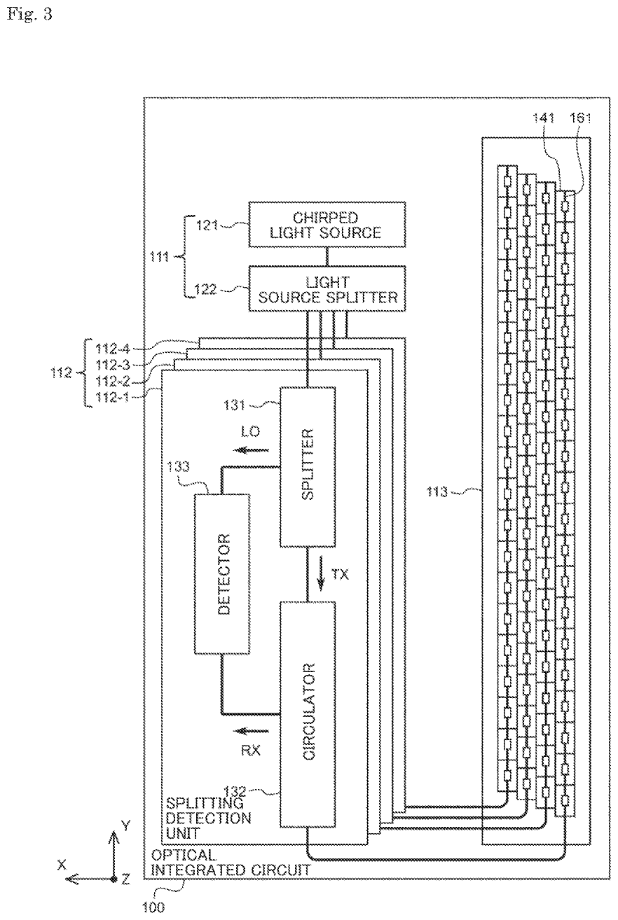

FIG. 3 illustrates an exemplary configuration of the optical integrated circuit 100 in FIG. 2.

The optical integrated circuit 100 has an optical waveguide formed on a semiconductor substrate by silicon photonics which is the application of semiconductor lithography and various functional optical elements are integrated on a single chip according to their material compositions and pattern shapes. The single-chip arrangement using silicon photonics allows the number of components to be reduced, which results in a less costly and smaller size structure.

In FIG. 3, the optical integrated circuit 100 includes a light source unit 111, a splitting detection unit 112, and a scanner unit 113. In the optical integrated circuit 100, the light source unit 111, the splitting detection unit 112, and the scanner unit 113 are formed and integrated on the same semiconductor substrate.

In the optical integrated circuit 100, the splitting detection unit 112 and the scanner unit 113 are configured with four channels, which allows a single circuit to emit and receive four beams simultaneously so that ranging and velocity measurement can be carried out simultaneously at four points.

The light source unit 111 includes a chirped light source 121 and a light source splitter 122. The chirped light source 121 includes, for example, a narrow line width laser element and an optical frequency detector to generate narrow line width light (chirped light) having an optical frequency varied linearly over time.

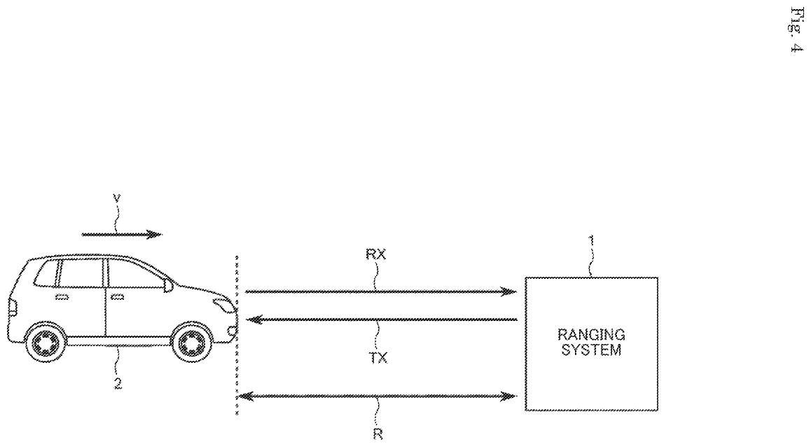

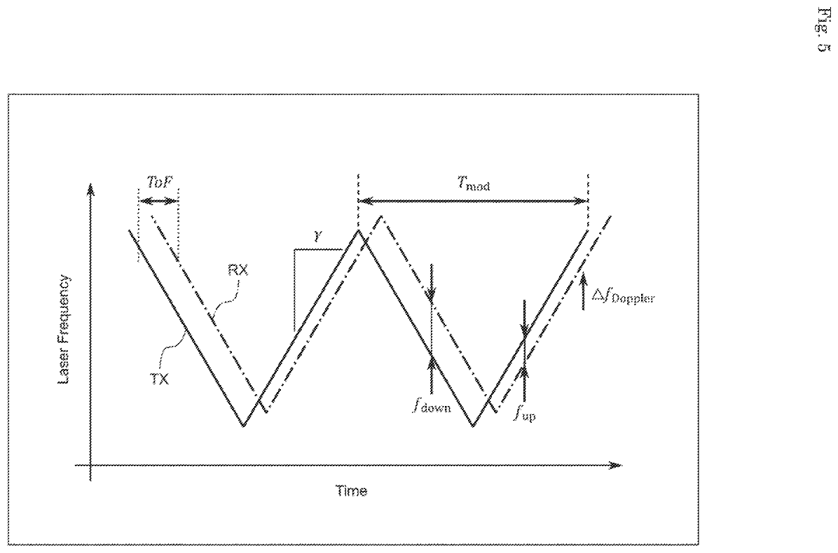

The light source splitter 122 distributes the power of the chirped light to the four channels. Note that the principles of how measurement using chirped light works will be described later with reference to FIGS. 4 and 5.

The splitting detection units 112-1 to 112-4 each include a splitter 131, a circulator 132, and a detector 133. Hereinafter, the splitting detection units 112-1 to 112-4 will be simply referred to as the splitting detection unit 112 unless it is necessary to distinguish them.

The splitter 131 supplies a part (for example about 10%) of the power of chirped light to the detector 133 as local oscillation light, and the reminder as transmission light to the circulator 132. The local oscillation light is also referred to as LO (Local Oscillator) light and the transmission light as TX (Transmitter) light.

The circulator 132 is an optical element that can direct light to different ports depending on the direction of propagation. The circulator 132 transmits the transmission light from the splitter 131 to the scanner unit 113 while directing received light from the scanner unit 113 to the detector 133 to prevent the light from flowing back to the splitter 131. The received light is also referred to as RX (receiver) light.

The detector 133 includes for example an optical interferometer and a balanced photodiode (BPD). The detector 133 outputs, as a current, the difference frequency between the local oscillation light from the splitter 131 and the received light from the circulator 132. The difference frequency is also commonly referred to as a beat frequency.

With reference to FIGS. 4 and 5, the principles of how measurement by the ranging system 1 works will be described. As shown in FIG. 4, assume that upon measuring the distance R to a target 2 to be measured and a relative velocity v with respect to the target 2 by the ranging system 1, transmitter light (TX light) is emitted and receiver light (RX light) is received as reflected light thereof.

FIG. 5 illustrates the relation between the transmitter light and the receiver light when the ordinate represents the laser frequency and the abscissa represents time. In FIG. 5, the solid triangular wave represents the transmitter light (TX light) and the single-dotted triangular wave represents the receiver light (RX light).

At the time, the chirp includes a period of falling optical frequency (down chirp) and a period of rising optical frequency (up chirp), and the combined period of the down chirp and the up chirp (Tmod in FIG. 5) corresponds to ranging of one point.

This type of LiDAR that uses such chirped light for ranging is called FMCW LiDAR.

The beat frequency in the down chirp (fdown in FIG. 5) and the beat frequency in the up chirp (fup in FIG. 5) are measured, so that the distance R from the ranging system 1 to the target 2 and the relative velocity v between the ranging system 1 and the target 2 can be calculated using the following expressions (1) and (2).

### [Math. 1]

$${f}_{down} + {f}_{up} = \frac{4 γ R}{c} \qquad ( 1 )$$

In expression (1), R represents the distance (m) from the ranging system 1 to the target 2. Also, γ represents the chirp speed (Hz/s), and c represents the velocity of light (m/s). ToF in FIG. 5 can be expressed as τ=2R/c, and the right side of expression (1) is derived from the relation between τ and γ.

### [Math. 2]

$${f}_{down} - {f}_{up} = \frac{2 v}{{λ}_{laser}} \qquad ( 2 )$$

In expression (2), v represents the relative velocity (m/s) between the ranging system 1 and the target 2. Also, Maser represents the center wavelength of the light source (nm). The ΔfDoppler in FIG. 5 can be expressed as ΔfDoppler=(v/c)flaser, and from these relations, the right side of expression (2) is derived.

Referring back to FIG. 3, the scanner unit 113 includes four pixel arrays arranged side by side and each including 20 pixels with a MEMS grating switch as one pixel.

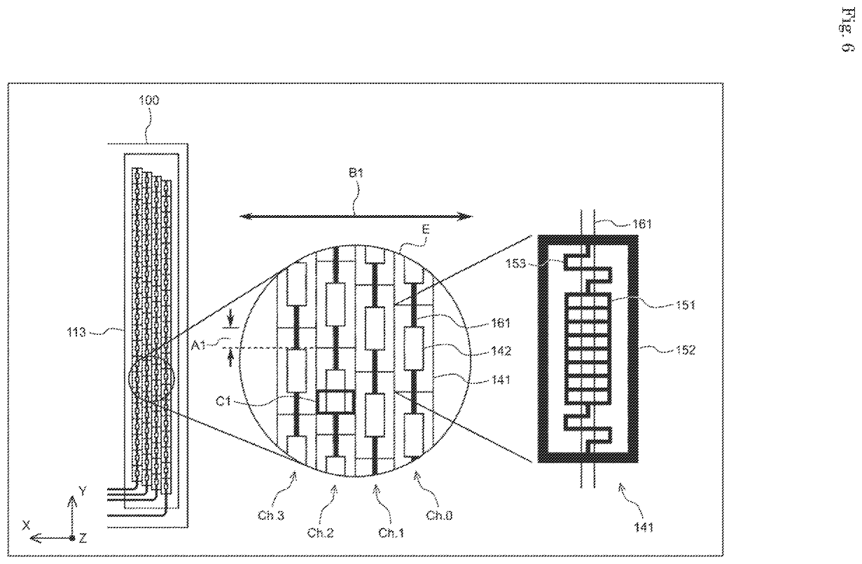

A detailed exemplary structure of the scanner unit 113 is shown in FIG. 6. FIG. 6 illustrates a four-channel configuration including Ch. 0 to Ch. 3, when one pixel array is referred to as one channel.

As shown in FIG. 6, the pixel 141 includes a grating 151 formed of a conductive material such as Poly-Si above a waveguide 161 made of silicon, a pixel frame 152, and an elastic member 153 such as a spring.

The grating 151 is for example a diffraction grating of a rectangular conductive material with a plurality of slit-like holes at prescribed intervals, and the interval between the slits ranges from approximately 0.1 to 10 times the wavelength of the light used by the switch. The pixel frame 152 is fixed to the substrate, and the grating 151 is fixed to the pixel frame 152 through the elastic member 153.

Although not shown, the pixel frame 152 and the substrate are each connected with an electrode and insulated from each other. When prescribed voltage is applied between the pixel frame 152 and the substrate, the grating 151 can be moved up and down with respect to the substrate depending on the level of the voltage according to the principles of electrostatic MEMS.

When the grating 151 is in a lower position, in other words, away from the substrate, light that passes through the waveguide 161 is emitted from the grating 151 without passing under the pixel 141, while conversely light incident on the grating 151 is captured by the waveguide 161. This state is called an on state.

Meanwhile, when the grating 151 is in an upper position, in other words, closer to the substrate, light passing through the waveguide 161 passes under the pixel 141 and nothing is emitted from the grating 151, and light incident on the grating 151 is either reflected or absorbed by the substrate and not taken up by the waveguide 161. This state is called an off state.

In this way, the pixel 141 has a structure that couples light between a free space and the waveguide 161 and an optical switch that switches between passing and blocking of light to the waveguide 161. Such a structure allows the position of light incidence and emission to be controlled, in other words, operation as a scanner compatible with LiDAR is enabled. More specifically the pixel 141 can form a movable grating coupler according to electrostatic MEMS. The movable grating coupler using electrostatic MEMS has the optical waveguide switch and the grating in an integrated manner, so that a high-density pixel array can be provided.

As shown in FIG. 6, in the scanner unit 113, 20 pixels 141 that belong to the same channel among the four channels Ch. 0 to Ch. 3 are connected in a row in the vertical direction (in the Y-direction in the figure) by the waveguide 161 under the pixels 141. More specifically the scanner unit 113 has pixel arrays each including a plurality of pixels 141 connected by a single waveguide 161 and arranged at a prescribed pitch in the same direction (the Y-direction in the figure) as the waveguide 161, and the four channels Ch. 0 to Ch. 3 are provided, with the pixel array serving as one channel.

As for each of the four channels Ch. 0 to Ch. 3, the pixels 141 that belong to adjacent channels are shifted from each other in the vertical direction (the Y direction in the figure) by a prescribed a shift amount from each other, or in the example in FIG. 6, by ¼ of the pixel vertical pitch (which corresponds to the shift amount between the channels Ch. 2 and Ch. 3 indicated by A1 in the figure). In other words, between the pixels 141 in each channel and the pixels 141 in another adjacent channel, the light emitters (light emitter/receiver 142) at least partly overlap in the direction (the X-direction in the figure) crossing the same direction as the waveguide 161 (the Y direction in the figure). As will be described in detail below, each pixel has an overlapping Y-coordinate coverage with its adjacent pixel, which allows a defective switch to be substituted by signal processing.

In the example in FIG. 6, the amount of shift between the channels is ¼ of the pixel vertical pitch, but the amount of shift between the channels needs only be a prescribed width smaller than the pixel vertical pitch. For example, the amount of shift between the channels can be determined on the basis of the relation between the pixel vertical pitch and the number of the channels. Note that the number of the channels is not limited to 4 as long as there are multiple channels.

In the enlarged area E in the circle shown in FIG. 6, the area of the light receiver/emitter 142 corresponds to the area in each pixel 141 where the slits of the grating 151 are located, and the area indicates the effective light emission and reception area in the pixel 141. This pixel arrangement is combined with the external scanner 12 (FIG. 1) that performs scanning (scans) in the horizontal direction (the X-direction indicated by B1 in the figure) to allow a smaller resolution than that of the pixel 141 to be obtained by the signal separation processing which will be described. In the example in FIG. 6, the minimum resolution corresponds to the area enclosed by a frame C1, i.e., ¼ of the pixel area.

### (Scanning Method}

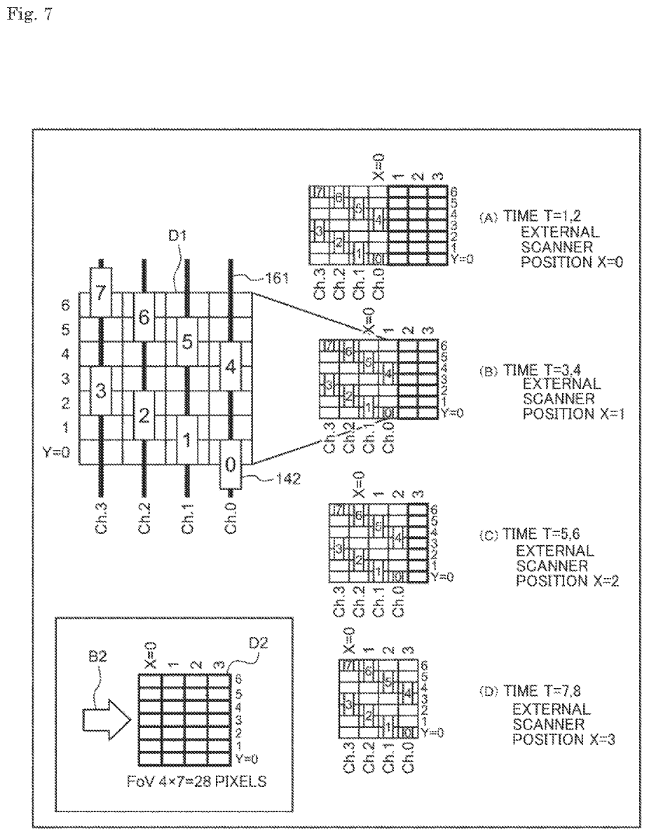

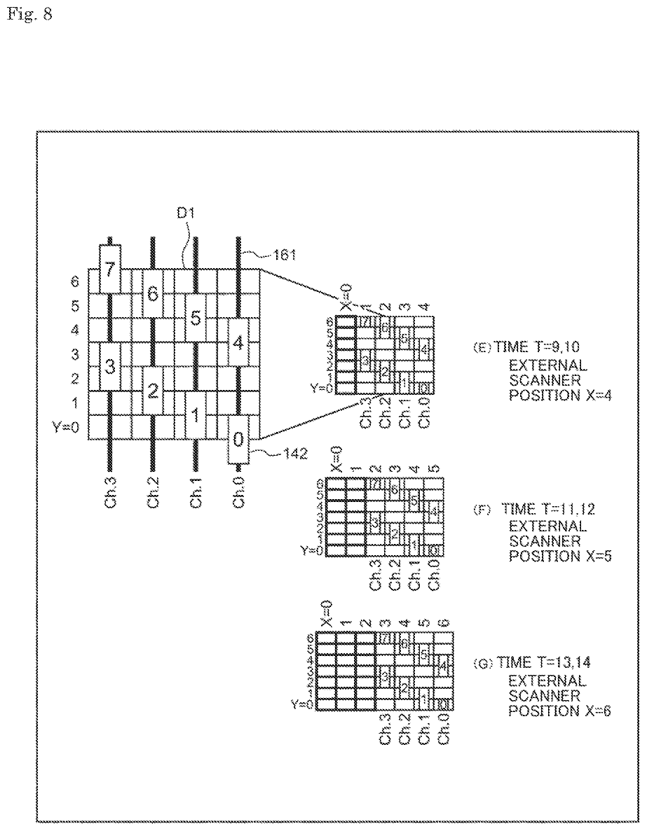

Now, an exemplary scanning method by the ranging system 1 will be described with reference to FIGS. 7 and 8.

In FIGS. 7 and 8, two types of lines are marked in a grid shape, the line D1 in a grid shape represents a resolution after signal separation processing, and each grid corresponds to the frame C1 in FIG. 6. D2 in a grid shape represents a field of view (FoV) to be measured, and the external scanner 12 scans the field of view in the horizontal direction (the X-direction indicated by B2 in the figure). The light receiver/emitter 142 in each pixel 141 has a MEMS grating switch (hereinafter also referred to as a MEMS switch), and each MEMS switch is numbered to identify the MEMS switch.

In the SiP 10 shown in FIG. 2, the number of the pixels 141 arranged in the scanner units 113 in the optical integrated circuits 100-1 to 100-3 is 240 (3×80 pixels), but here, for ease of description, a simplified example with fewer pixels will be described.

In FIGS. 7 and 8, the pixel array (MEMS switch array) has a total of 8 pixels for the four channels, Ch. 0 to Ch. 3. The field of view (FoV) for 2D scanning is assumed to be 4 pixels in the horizontal direction and 7 pixels in the vertical direction, i.e., 4×7 pixels=28 pixels. In FIGS. 7 and 8, measurement for the 28 pixels is completed by 14 time steps from time T=1 to time T=14. One time step corresponds to the combined period of down chirp and up chirp (Tmod) as described with reference to FIG. 5.

### (A) T=1, 2, X=0

At time T=1, 2, the outgoing and the incoming light of the three MEMS switches (0, 4) that belong to Ch. 0 are aligned to the field of view X=0 by the external scanner 12. At time T=1, MEMS switch (0) and at time T=2, MEMS switch (4) emit light sequentially to receive the reflected light from target 2. The output from the detector 133 is converted into received data by the AFE 102A.

A label {X, Y} is assigned to the received data obtained in this way using the coordinates (X, Y) of the corresponding field of view, which in turn can be expressed as {0, 0}, {0, 3&4}. Here, “3&4” indicates that the received signals for Y=3 and Y=4 are mixed. Similarly in the following description, the mixture of received signals for multiple Y coordinates will be denoted with “&.”

In this way, at times T=1, 2, Ch. 0 is at field of view X=0, and the MEMS switch (0) and MEMS switch (4) emit light and the light is detected at times T=1 and T=2, respectively, so that the received data is obtained and labeled according to the corresponding field of view.

### (B) T=3, 4, X=1

At time T=3, 4, the outgoing light and the incoming light of the MEMS switch (1, 5) are aligned to the field of view X=0, and the outgoing light and incoming light of the MEMS switch (0, 4) are aligned to the field of view X=1. The MEMS switch (0, 1) and the MEMS switch (4, 5) emit and receive light sequentially at time T=3 and at time T=4, respectively. When labels are assigned to the received data obtained here according to the coordinates of the field of view, the labels are expressed as {1, 0}, {0, 0&1}, {1, 3&4}, and {0, 4&5} in this order.

### (C) T=5, 6, X=2

At times T=5, 6, the outgoing light and the incoming light of the MEMS switches (2, 6) are aligned to the field of view X=0, the outgoing light and the incoming light of the MEMS switches (1, 5) to the field of view X=1, and the outgoing and incoming light of the MEMS switches (0, 4) to the field of view X=2. MEMS switch (0, 1, 2) and MEMS switch (4, 5, 6) emit and receive light sequentially at time T=5 and at time T=6, respectively. When labels are assigned to the received data obtained here according to the coordinates of the field of view, the labels are expressed as {2, 0}, {1, 0&1}, {0, 1&2}, {2, 3&4}, {1, 4&5}, and {0, 5&6} in this order.

### (D) T=7, 8, X=3

At time T=7, 8, the outgoing light and the incoming light of the MEMS switches (3, 7) are aligned to the field of view X=0, the outgoing light and incoming light of the MEMS switches (2, 6) with X=1, the outgoing light and incoming light of the MEMS switches (1, 5) with X=2, and the outgoing light and the incoming light of the MEMS switches (0, 4) with X=3. MEMS switches (0, 1, 2, 3) and MEMS switches (4, 5, 6, 7) emit and receive light sequentially at time T=7 and at time T=8, respectively. When labels are assigned to the received data obtained here according to the coordinates of the field of view, the labels are expressed as {3, 0}, {2, 0&1}, {1, 1&2}, {0, 2&3}, {3, 3&4}, {2, 4&5}, {1, 5&6}, and {0, 6&7}.

### (E) T=9, 10, X=4

At times T=9, 10, the outgoing light and the incoming light from the MEMS switches (3, 7) are aligned to the field of view X=1, the outgoing light and the incoming light from the MEMS switches (2, 6) to the field of view X=2, and the outgoing light and the incoming light from the MEMS switches (1, 5) to the field of view X=3. The MEMS switches (1, 2, 3) and MEMS switches (5, 6, 7) emit and receive light sequentially at time T=9 and at time T=10, respectively. When labels are assigned to the received data obtained here according to the coordinates of the field of view, the labels are expressed as {3, 0&1}, {2, 1&2}, {1, 2&3}, {3, 4&5}, {2, 5&6}, and {1, 6&7}.

### (F) T=11, 12, X=5

At times T=11, 12, the outgoing light and the incoming light of the MEMS switches (3, 7) are aligned to the field of view X=2 and the outgoing light and incoming light of the MEMS switches (2, 6) are aligned to the field of view X=3. The MEMS switches (2, 3) and the MEMS switches (6, 7) emit and receive light sequentially at time T=11 and at time T=12, respectively. When labels are assigned to the received data obtained here according to the coordinates of the field of view, the labels are expressed as {3, 1&2}, {2, 2&3}, {3, 5&6}, and {2, 6&7}.

### (G) T=13, 14, X=6

At T=13, 14, the outgoing light and the incoming light of MEMS switches (3, 7) are aligned to the field of view X=3. The MEMS switch (3) and the MEMS switch (7) emit light and receive light sequentially at time T=13 and at time T=14, respectively. When labels are assigned to the received data obtained here according to the coordinates of the field of view, the labels are expressed as {3, 2&3}, and {3, 6&7}.

In the ranging system 1, the scanning as described above is performed, so that measurements of 28 pixels are made in 14 time steps from time T=1 to time T=14, and the received data labeled according to the corresponding field of views (FoV) is obtained.

### (Distance and Velocity Calculation Method)

In the ranging system 1, the distance from and velocity at each set of coordinates {X, Y} assigned as a label are calculated using the received data obtained by the above described scanning. For example, the DSP 102B performs a Discrete Fourier Transformation (DFT) on each received data sequence to obtain a frequency spectrum. Here, since there are down-chirp and up-chirp periods in the time step for one measurement, a discrete Fourier transform calculation for each period is performed to obtain two spectra per measurement.

The spectrum of {0, 0} obtained from the MEMS switch (0) at time T=1 and the spectrum of {0, 0&1} obtained from the MEMS switch (1) at time T=3 are multiplied for each frequency to detect the frequency at which the intensity of the resulting spectral product peaks. In this way, the beat frequency (fdown, fup) corresponding to the coordinates {0, 0} of the field of view is obtained. Using the above expressions (1) and (2), the distance (R) and velocity (v) are calculated. Using the product of the spectra, the signal at the coordinates {0, 0} is emphasized, and the signal corresponding to the coordinates {0, 1} superimposed on measurement data about the MEMS switch (1) at time T=3 can be excluded from peak detection.

Similarly, the spectrum of {0, 0&1} obtained from the MEMS switch (1) at time T=3 and the spectrum of {0, 1&2} obtained from the MEMS switch (2) at time T=5 are multiplied for each frequency, and the frequency at which the intensity of the resulting spectral product peaks is detected. In this way, the beat frequency corresponding to the coordinates {0, 1} of the field of view can be obtained, and the distance and velocity can be calculated.

The product of the spectra provides the distance and velocity corresponding to the coordinates of the field of views (28 pixels (4×7 pixels) in the example in FIGS. 7 and 8).

The ranging system 1 includes an optical integrated circuit 100 including a scanner unit 113 including a plurality of channels each corresponding, as one channel, to a 1D pixel array (MEMS switch array) including a plurality of pixels each having an optical radiation structure and an optical waveguide switch (pixels having MEMS grating switches), and the plurality of the channels are shifted between channels by a width that is smaller than the pixel pitch. The SiP 10 including the optical integrated circuit 100 is combined with the external scanner 12 for scanning, so that angular resolutions higher than the pixel pitch can be provided. In this way, ranging with higher angular resolutions can be carried out.

In particular, according to the feature disclosed in PTL 1, in order to increase angular resolutions, the pixels must be miniaturized to reduce the pixel pitch. A structure with movable parts such as MEMS grating switches may suffer from reduced mechanical strength and defects attributable to the reduction when miniaturized. Meanwhile, since angular resolutions can be increased without the need for pixel miniaturization according to the present disclosure, the issue of reduced mechanical strength can be avoided, and as a result, defects can be prevented.

### (Method for Substituting MEMS Switches)

Now, a method for substituting a defective MEMS switch will be described.

Possible failure modes for MEMS switches are a fixed-off failure, in which the switch is stuck in an off state and a fixed-on failure, in which the switch is stuck in an on state. In the fixed-off failure, only the pixel including the MEMS switch in question (defective pixel) is unable to emit and receive light, and the other pixels are not affected.

Meanwhile, the fixed-on failure causes a so-called line failure which has a significant impact since the pixel that includes the MEMS switch in question (defective pixel) is kept coupled to the waveguide below the pixel, and the pixels that share the waveguide with the defective pixel and are arranged nearer to the distal end of the line than the defective pixel are also unable to emit and receive light.

In this way, the fixed-on failure usually causes the entire channel including the MEMS switch in question to be unavailable for measurement. Even if such a failure occurs in a MEMS switch, the measurement can be continued for all pixels by performing the following calculation with the DSP 102B.

In the examples shown in FIGS. 7 and 8, assume that the MEMS switch (2) has a fixed-off failure. The coordinates of a field of view corresponding to Y=1, 2 are affected by the failure of the MEMS switch (2). For example, the distance and velocity corresponding to the coordinates {1, 1} of the field of view can be obtained, instead of the product of spectra described above, by finding the spectral difference obtained by subtracting the spectrum of {1, 0} obtained from the MEMS switch (0) at time T=3 from the spectrum of {1, 0&1} obtained from the MEMS switch (1) at time T=5 and detecting the frequency at which the intensity peaks. This allows the distance and velocity to be calculated without using the received data from the MEMS switch (2).

The distance and velocity corresponding to the coordinates {2, 1} of the field of view can be calculated using the spectral difference obtained by subtracting the spectrum of {2, 0} obtained from the MEMS switch (0) at time T=5 from the spectrum of {2, 0&1} obtained from the MEMS switch (1) at time T=7.

The distance and velocity corresponding to the coordinates {2, 2} of the field of view can be calculated using the spectral difference obtained by subtracting the spectrum of {2, 3} from the spectrum of {2, 2&3} obtained from the MEMS switch (3) at time T=11. Here, the spectrum of {2, 3} is obtained by multiplying the spectrum of {2, 2&3} by the spectrum of {2, 3&4} obtained from the MEMS switch (4) at time T=6 for each frequency and then finding a root thereof, i.e., calculating a square root of the spectral product.

Thereafter, the distance and velocity can be calculated in the same manner using the spectral difference for each of coordinates of the field of view corresponding to Y=1, 2 without using the received data from the MEMS switch (2). However, for some coordinates, the square root of a spectral product is used along with the spectral difference. If a switch with any switch number other than the MEMS switch (2) has a fixed-off failure, the measurement can be continued in the same manner using the spectral difference for the coordinates of the affected field of view (and also using a square root of a spectral product for some coordinates).

Now, assume that the MEMS switch (2) has a fixed-on failure in the examples shown in FIGS. 7 and 8. In this case, light emission and reception by the MEMS switch (6), which belongs to the same channel (Ch. 2) as the MEMS switch (2), is disabled. The coordinates of the field of view corresponding to Y=5, 6 are affected by the failure of the MEMS switch (6).

For example, the distance and velocity corresponding to the coordinates {1, 5} of the field of view can be calculated using the spectral difference obtained by subtracting the spectrum of {1, 4} from the spectrum of {1, 4&5} from the MEMS switch (5) at time T=6. Here, the spectrum of {1, 4} is obtained by calculating a square root of the spectral product of the spectrum of {1, 4&5} and the spectrum of {1, 3&4} obtained from the MEMS switch (4) at time T=4.

Thereafter, when the MEMS switch (2) has a fixed-on failure, the distance and velocity can be calculated similarly using the spectral difference (and also a square root of the spectral product for some coordinates) for each coordinate of the field of view corresponding to Y=5, 6 without using the received data from the MEMS switch (6). If a switch with any switch number other than the MEMS switch (2) has a fixed-on failure, the measurement can be continued in the same manner.

In the above description, there are eight MEMS switches for four channels and the field of view FoV corresponds to 28 pixels, but the same signal processing can be used to scan a higher resolution field of view (FoV) using MEMS switches in a larger number of pixels. In other words, when scanning a higher resolution field of view, measurement points corresponding to MEMS switches lost due to fixed-off or fixed-on failures can be substituted by signal processing using spectra such as spectral differences and spectral products obtained from received data from adjacent normal MEMS switches.

The substitution processing allows the ranging to continue even when a pixel has a failure. Note that the feature disclosed in PTL 1 does not include a method for addressing the failure modes, and ranging cannot be continued once a failure occurs in a pixel.

### 2. Modifications

### (Alternative Configuration of Optical Integrated Circuit)

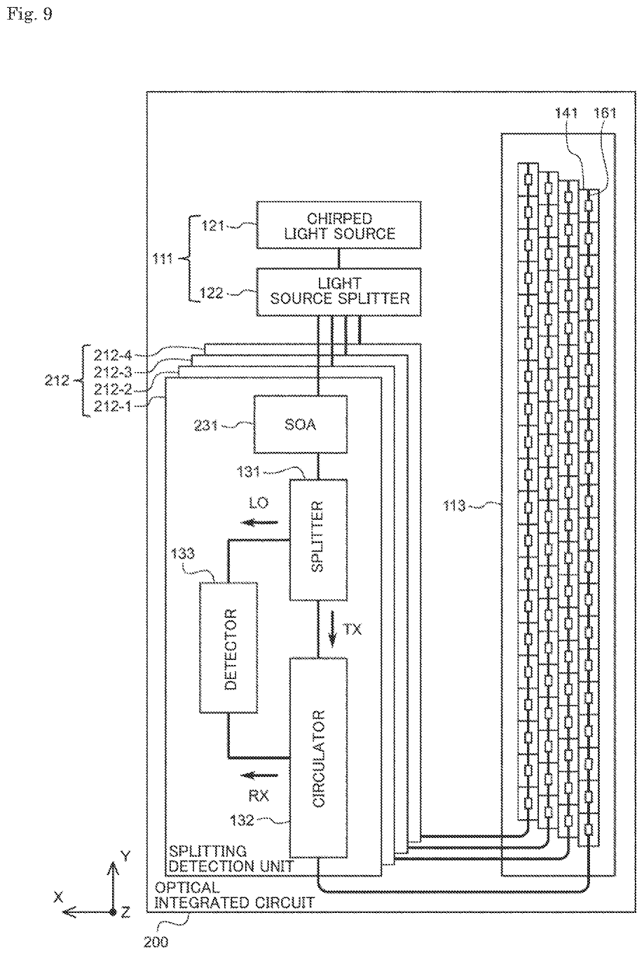

FIG. 9 illustrates another exemplary configuration of the optical integrated circuit in FIG. 2.

In an optical integrated circuit 200 in FIG. 9, elements corresponding to those of the optical integrated circuit 100 in FIG. 3 are denoted by the same reference characters, and description thereof will not be provided as appropriate. More specifically, the optical integrated circuit 200 is provided with a splitting detection unit 212 instead of the splitting detection unit 112. The splitting detection unit 212 includes splitting detection units 212-1 to 212-4.

The splitting detection units 212-1 to 212-4 each include an SOA 231 in addition to the splitter 131, the circulator 132, and the detector 133.

The SOA (Semiconductor Optical Amplifier) 231 is a device that has an input/output port for an optical waveguide and at least two electrodes, amplifies the power of input light according to the magnitude of current passed between the electrodes, and outputs the resulting light. Since the SOA 231 amplifies only the power without changing the optical frequency, the chirp form of the light source unit 111 is not changed by the amplification.

The SOA 231 provided in each channel of the optical integrated circuit 200 allows the laser output power of the channel to be increased to a higher level, so that ranging over long distances is enabled. In particular, if the optical integrated circuit 200 has many channels, it is desirable to provide an additional SOA 231 for each channel, because splitting a single chirped light source into many channels can easily result in insufficient transmission optical power per channel.

As for LiDAR compatible ranging apparatuses, the laser energy that can be emitted in the same direction per unit time is limited in accordance with safety standards for laser products, so-called eye-safe (e.g., JIS C 6802:2014). The MEMS switch with a fixed-on failure continues to emit transmission light in the same direction, unlike a normal switch, and there is a risk that the output quantity of light in the channel may exceed the limit of the eye-safe standards. At the time, an independent SOA 231 is provided for each channel, so that the drive current for the SOA 231 in the channel with a fixed-on failure can be controlled to be approximately 0 to keep the power of the transmission light low, and thus deviation from the safety standards can be prevented.

### (Alternative Configuration of Ranging Apparatus)

FMCW LiDAR has been described as one kind of LiDAR, but other kinds of LiDAR than FMCW LiDAR may be applied to the ranging apparatus to which the present disclosure is applied. For example, dToF LiDAR (direct Time of Flight LiDAR) can be used, in which the light source is not subjected to frequency modulation, but instead delay time from transmission to reception is measured using for example by a time digitizer (TDC: Time to Digital Converter) circuit.

According to FMCW LiDAR, the distance is obtained from the frequency spectrum of the received signal but according to dToF LiDAR, the distance to the target is obtained by creating a histogram representing the intensity of the received signal at each time and detecting the peak thereof. As for FMCW LiDAR, the product of spectra is used to obtain the received signal for each coordinate of the field of view (FoV) from the received signal of each switch, while according to dToF LiDAR, signal separation is similarly allowed for each coordinate of the field of view (FoV) by obtaining the product of intensities for each time in histograms obtained from two switches.

Similarly, when a switch has a fixed-on or fixed-off failure, the distance can be calculated using the product of and difference between histograms on the basis of received data from adjacent normal switches.

### (Alternative Configuration of External Scanner)

In the foregoing description, a Risley prism is used as the external scanner 12, but the present disclosure is not limited by the example, and any scanner that can be used for LiDAR can be used. Specifically for example, a MEMS mirror, a voice coil mirror, a galvano-mirror, a polyhedral rotating mirror, a head-spin type mechanical scanner or a liquid crystal scanner (including LCOS (Liquid Crystal on Silicon)) can be used.

### (Alternative Structure of Pixel)

In the foregoing description, a MEMS grating switch is used for the pixel 141 as an example, but the switch is not limited to electrostatic MEMS based switches, and any other pixel structures may be employed. For example, any structure capable of coupling light between a free space and an optical waveguide and any optical switch that controls the passage and blocking of the optical waveguide can be used. Specifically an optical waveguide switch such as a thermo-optical switch and an electro-optical switch can be combined with a non-mobile grating coupler to form a pixel with the same function.

### (Alternative Structure of Ranging System)

In the foregoing description, a MEMS switch is used for both transmission and reception, but the present disclosure is not limited by this example. For example, separate optical integrated circuits may be provided for light transmission and reception, and a scanner structure to which the present disclosure is applied can be used for one or both of the circuits. Although providing circuits separately for transmission and reception increases the number of components, the structure is advantageous in that the need for the circulator 132 for the splitting detection units 112 and 212 (FIGS. 3 and 9) is eliminated, and the structure also eliminates non-ideal factors such as unintended reflection of transmission light in the waveguide or optical circuit path that may cause noise components to be superimposed on received light.

Note that embodiments of the present disclosure are not limited to those described and can be modified in various manners without departing from the scope and spirit of the present disclosure. The advantageous effects described herein are merely exemplary and are not limiting, and other advantageous effects may be exhibited.

Herein, the term system refers to a collection of a plurality of elements (such as devices and modules (components)) and all the elements may or may not be located in the same housing. Accordingly, a plurality of devices accommodated in separate housings and connected over a network and a single device in which a plurality of modules are accommodated in one casing both constitute a system. Herein, “1D” stands for one-dimensional and “2D” for two-dimensional.

Furthermore, the present disclosure can be configured as follows:

(1)

A ranging apparatus comprising a scanner unit that has pixel arrays each including a plurality of pixels connected by one waveguide, the pixels being arranged at a prescribed pitch in a first direction in the same direction as that of the waveguide, wherein
the scanner unit includes a plurality of channels, the pixel array serves as one channel, and
the plurality of channels are arranged in a second direction crossing the first direction, and shifted between channels by a prescribed width smaller than the prescribed pitch.

(2)

The ranging apparatus according to (1), wherein the pixel has
a structure that couples light between a free space and the waveguide, and
an optical switch configured to switch between passage and blocking of light to the waveguide.

(3)

The ranging apparatus according to (2),
wherein the pixel is configured including a movable grating coupler using electrostatic MEMS.

(4)

The ranging apparatus according to any one of (1) to (3),
wherein light emitters at least partly overlap in the second direction between pixels in each channel and pixels in another adjacent channel.

(5)

The ranging apparatus according to any one of (1) to (4),
wherein the first direction and the second direction are orthogonal to each other.

(6)

The ranging apparatus according to any one of (1) to (5), further including a light source unit configured to generate chirped light, and
a splitting detection unit configured to supply transmission light obtained by splitting the chirped light to the scanner unit and detect received light supplied from the scanner unit,
wherein
the scanner unit emits, from a light emitter of the pixel, and
the transmission light from the splitting detection unit, receives light reflected by a target at a light receiver of the pixel, and
supplies the received light to the splitting detection unit.

(7)

The ranging apparatus according to (6), further including a signal processing unit configured to calculate ranging information related to the target on the basis of received data obtained from the received light.

(8)

The ranging apparatus according to (7),
wherein the signal processing unit calculates the distance to the target or a relative velocity with respect to the target by using the product of a first spectrum obtained from a first pixel at first time and a second spectrum obtained from a second pixel at second time.

(9)

The ranging apparatus according to (7),
wherein the signal processing unit calculates the distance to the target or a relative velocity with respect to the target by using the difference between a first spectrum obtained from a first pixel at first time and a second spectrum obtained from a second pixel at second time.

(10)

The ranging apparatus according to (9),
wherein the signal processing unit calculates the second spectrum, as required, by multiplying the first spectrum by a third spectrum obtained from a third pixel at third time and then obtaining a square root thereof.

(11)

The ranging apparatus according to any one of (1) to (10),
wherein the prescribed width is determined on the basis of relation between the prescribed pitch and the number of the channels.

(12)

The ranging apparatus according to any one of (1) to (11),
wherein ranging according to FMCW LiDAR is carried out.

(13)

An optical integrated circuit including a light source unit configured to generate chirped light,
a scanner unit that has pixel arrays each including a plurality of pixels connected by one waveguide, the pixels being arranged at a prescribed pitch in a first direction in the same direction as that of the waveguide, and
a splitting detection unit configured to supply transmission light obtained by splitting the chirped light to the scanner unit and detect received light from the scanner unit,
wherein
the scanner unit includes a plurality of channels, the pixel array serves as one channel, and
the plurality of channels are arranged in a second direction crossing the first direction, and shifted between channels by a prescribed width smaller than the prescribed pitch.

(14)

The optical integrated circuit according to (13),
wherein the light source unit, the scanner unit, and the splitting detection unit are integrated on a semiconductor substrate.

(15)

A ranging system including an optical integrated circuit, the optical integrated circuit including a light source unit configured to generate chirped light,
a scanner unit that has pixel arrays each including a plurality of pixels connected by one waveguide, the pixels being arranged at a prescribed pitch in a first direction in the same direction as that of the waveguide, and
a splitting detection unit configured to supply transmission light obtained by splitting the chirped light to the scanner unit and detect received light from the scanner unit, and
an external scanner configured to at least carry out scanning in a second direction crossing the first direction,
wherein
the scanner unit includes a plurality of channels, the pixel array serves as one channel, and
the plurality of channels are arranged in the second direction, and shifted between channels by a prescribed width smaller than the prescribed pitch.

(16)

The ranging system according to (15),
wherein a plurality of the optical integrated circuits are arranged in the first direction, and
the external scanner carries out one-dimensional scanning in the second direction.

(17)

The ranging system according to (15) or (16),
wherein the first direction is orthogonal to the second direction.

(18)

The ranging system according to any one of (15) to (17),
wherein ranging according to FMCW LiDAR is carried out.

### REFERENCE SIGNS LIST

1 Ranging system
10 SiP
11 Collimator
12 External scanner
20 1D scanner array
100, 100-1 to 100-3 Optical integrated circuit
111 Light source unit
112, 112-1 to 112-4 Splitting detection unit
113 Scanner unit
121 Chirped light source
122 Light source splitter
131 Splitter
132 Circulator
133 Detector
141 Pixel
142 Light receiver/emitter
151 Grating
152 Pixel frame
153 Elastic member
161 Waveguide
200 Optical integrated circuit
212, 212-1 to 212-4 Splitting detector
231 SOA

1. A ranging apparatus comprising a scanner unit that has pixel arrays each including a plurality of pixels connected by one waveguide, the pixels being arranged at a prescribed pitch in a first direction in the same direction as that of the waveguide, wherein
the scanner unit includes a plurality of channels, the pixel array serves as one channel, and
the plurality of channels are arranged in a second direction crossing the first direction, and shifted between channels by a prescribed width smaller than the prescribed pitch.

2. The ranging apparatus according to claim 1, wherein the pixel has a structure that couples light between a free space and the waveguide, and
an optical switch configured to switch between passage and blocking of light to the waveguide.

3. The ranging apparatus according to claim 2,
wherein the pixel is configured of a movable grating coupler using an electrostatic MEMS.

4. The ranging apparatus according to claim 1,
wherein light emitters at least partly overlap in the second direction between pixels in each channel and pixels in another adjacent channel.

5. The ranging apparatus according to claim 1,
wherein the first direction and the second direction are orthogonal to each other.

6. The ranging apparatus according to claim 1, further comprising:
a light source unit configured to generate chirped light;
a splitting detection unit configured to supply transmission light obtained by splitting the chirped light to the scanner unit and detect received light supplied from the scanner unit,
wherein the scanner unit emits, from a light emitter of the pixel, the transmission light from the splitting detection unit, and
receives light reflected by a target at a light receiver of the pixel, and supplies the received light to the splitting detection unit.

7. The ranging apparatus according to claim 6, further comprising a signal processing unit configured to calculate ranging information related to the target on the basis of received data obtained from the received light.

8. The ranging apparatus according to claim 7,
wherein the signal processing unit calculates a distance to the target or a relative velocity with respect to the target by using the product of a first spectrum obtained from a first pixel at first time and a second spectrum obtained from a second pixel at second time.

9. The ranging apparatus according to claim 7,
wherein the signal processing unit calculates a distance to the target or a relative velocity with respect to the target by using a difference between a first spectrum obtained from a first pixel at first time and a second spectrum obtained from a second pixel at second time.

10. The ranging apparatus according to claim 9,
wherein the signal processing unit calculates the second spectrum, as required, by multiplying the first spectrum by a third spectrum obtained from a third pixel at third time and then obtaining a square root thereof.

11. The ranging apparatus according to claim 1,
wherein the prescribed width is determined on the basis of relation between the prescribed pitch and the number of the channels.

12. The ranging apparatus according to claim 6,
wherein
ranging according to FMCW LiDAR is carried out.

13. An optical integrated circuit comprising:
a light source unit configured to generate chirped light;
a scanner unit that has pixel arrays each including a plurality of pixels connected by one waveguide, the pixels being arranged at a prescribed pitch in a first direction in the same direction as that of the waveguide; and
a splitting detection unit configured to supply transmission light obtained by splitting the chirped light to the scanner unit and detect received light from the scanner unit,
wherein
the scanner unit includes a plurality of channels, the pixel array serves as one channel, and
the plurality of channels are arranged in a second direction crossing the first direction, and shifted between channels by a prescribed width smaller than the prescribed pitch.

14. The optical integrated circuit according to claim 13, wherein the light source unit, the scanner unit, and the splitting detector are integrated on a semiconductor substrate.

15. A ranging system comprising:
an optical integrated circuit, the optical integrated circuit including, a light source unit configured to generate chirped light,
a scanner unit that has pixel arrays each including a plurality of pixels connected by one waveguide, the pixels being arranged at a prescribed pitch in a first direction in the same direction as that of the waveguide, and
a splitting detection unit configured to supply transmission light obtained by splitting the chirped light to the scanner unit and detect received light from the scanner unit; and
an external scanner configured to at least carry out scanning in a second direction crossing the first direction,
wherein
the scanner unit includes a plurality of channels, the pixel array serves as one channel, and
the plurality of channels are arranged in the second direction, and shifted between channels by a prescribed width smaller than the prescribed pitch.

16. The ranging system according to claim 15,
wherein a plurality of the optical integrated circuits are arranged side by side in the first direction, and
the external scanner carries out one-dimensional scanning in the second direction.

17. The ranging system according to claim 16,
wherein the first direction is orthogonal to the second direction.

18. The ranging system according to claim 15,
wherein ranging according to FMCW LiDAR is carried out.
